(19) United States
(12) Patent Application Publication
(10) Pub. No.: US 2002/0069415 A1
(43) Pub. Date: Jun. 6, 2002

(54) User interface and navigator for interactive television

(76) Inventors: Charles Humbard, Rockville, MD (US); Susan Malone, McLean, VA (US); Mary Hicks, Chevy Chase, MD (US)

Correspondence Address: DORSEY & WHITNEY LLP, 1660 International Drive, Suite 400, McLean, VA, 22102, US

(21) Appl. No.: 09/946,781

(22) Filed: Sep. 6, 2001

Related U.S. Application Data
(60) Provisional application No. 60/231,338, filed on Sep. 8, 2000.

(51) Int. Cl. G06F 3/00; H04N 5/445; G06F 13/00; G09G 5/00

(52) U.S. Cl. 725/52; 725/60; 725/61; 725/37; 725/38; 345/649; 345/851; 345/700

(57) ABSTRACT

A user interface and navigator is provided that improves the viewer's viewing experience and provides improved access to programs, including interactive features. The user interface includes arrow keys and a select key, and may be embodied in a remote control device. Corresponding icons may then be displayed in an overlay fashion on a program, such as a television program. The navigator includes one or more solid, rotatable objects, with each of the objects having at least one face containing a selectable feature. In an embodiment, the solid, rotatable objects are cubes, and each of the cubes may have at least one feature corresponding to each of the six faces of the cubes.

### CROSS REFERENCE TO RELATED APPLICATION

This application hereby claims the benefit of the priority of U.S. Provisional Patent Application, Serial No. 60/231,338, filed Sep. 8, 2000, which is hereby incorporated by reference.

### TECHNICAL FIELD

The technical field is guides and interfaces for interactive television.

### BACKGROUND

Television programming today offers hundreds of choices of program channels for viewing. In addition, select programs may offer interactive features that enhance the viewer's experience. An example of an interactive feature may include electronic games in which one or more players manipulate characters or objects according to a set of game rules. Another example is a question and answer program in which the viewer submits a question, written using a keypad, for example, and receives a response from a character in the program. Still another example of an interactive feature is selection of camera viewing angle to watch a sporting event. Many other interactive features are also available for the viewer.

To navigate the hundreds of available programs, a program guide may be provided Such a program guide may be in a hard copy or electronic format. The program guide may list available choices by channel and by time of day in a flat, two-dimensional array. The program guide typically uses text (words and numerals) to convey information to the viewer. The program guide may take up the entire field of view on the television screen when displayed. Alternatively, the program guide may occupy only a portion of the television screen (such as the upper portion), thereby allowing display of the program and viewing by the viewer.

An electronic version of the program guide may be used in conjunction with a user interface such as a remote control device. The remote control device may include one or more buttons that may be used to navigate, or move, an on-screen cursor over the two-dimensional array until a desired program is highlighted. The remote control may include arrows and a numeric key pad. The arrows may be used to move up and down or left and right over the program guide. The numeric key pad may be used to enter a specific channel number.

When interactive features are provided with a television program, a system or menu similar to that of an electronic program guide may be used to display such interactive features. That is, the interactive features may be displayed in a simple grid format, or as single “buttons.” In either event, selection of the interactive features is hampered by the format of the menu. If a large number of interactive features are provided, such a menu may obscure the displayed television program.

When selecting television programs or interactive features, to operate the remote control, and to navigate the program guide or interactive menu, the viewer must often look directly at the remote control, thereby taking the viewer's eyes off the displayed program guide.

### SUMMARY

A novel user interface and navigator is provided that improves the viewer's viewing experience and provides improved access to programs, including interactive features. The user interface and the navigator may be used in conjunction with a television delivery system that uses conventional television program delivery mechanisms. The user interface and the navigator may also be used for other video programming, including streaming video provided over the Internet, and with any other systems, including wired and wireless systems, or mechanisms that deliver still or moving video to television, a personal computer, a personal data assistant, or any other device capable of displaying the video.

The user interface includes arrow keys and a select key, and may be embodied in a remote control device. Corresponding icons may then be displayed in an overlay fashion on a program, such as a television program. The navigator includes one or more solid, rotatable objects, with each of the objects having at least one face containing a selectable feature. In an embodiment, the solid, rotatable objects are cubes, and each of the cubes may have at least one feature corresponding to each of the six faces of the cubes. More than six features may be accommodated by use of a hierarchical structure. Each of the cubes may represent a specific class of features. For example, one cube may provide access to video games. Another cube may provide program enhancements, such as a time line related to a displayed history program.

Not all displayed programs may use all the six or more features assigned to each of the cubes. In these cases, only the available features are displayed on the cube faces, and if fewer than six features are available, one or more of the cube faces may be blank.

### DESCRIPTION OF THE DRAWINGS

The detailed description will refer to the following drawings in which like numerals refer to like objects, and in which:

FIG. 1 illustrates a system incorporating a user interface and an electronic navigator;

FIGS. 2a and 2b illustrate an interactive television navigator;

FIG. 3 illustrates the navigator of FIG. 2a with a feature selection highlighted;

FIG. 4 illustrates examples of selections and features available with the navigator of FIG. 2a;

FIG. 5 is a block diagram of a program delivery system that uses the navigator of FIG. 2a;

FIG. 6 is a block diagram of an alternative program delivery system that uses the navigator of FIG. 2a;

FIGS. 7-13 illustrate additional features of the navigator of FIG. 2a; and

FIGS. 14 and 15 are block diagrams illustrating routines for displaying and operating the navigator of FIG. 2a.

### DETAILED DESCRIPTION

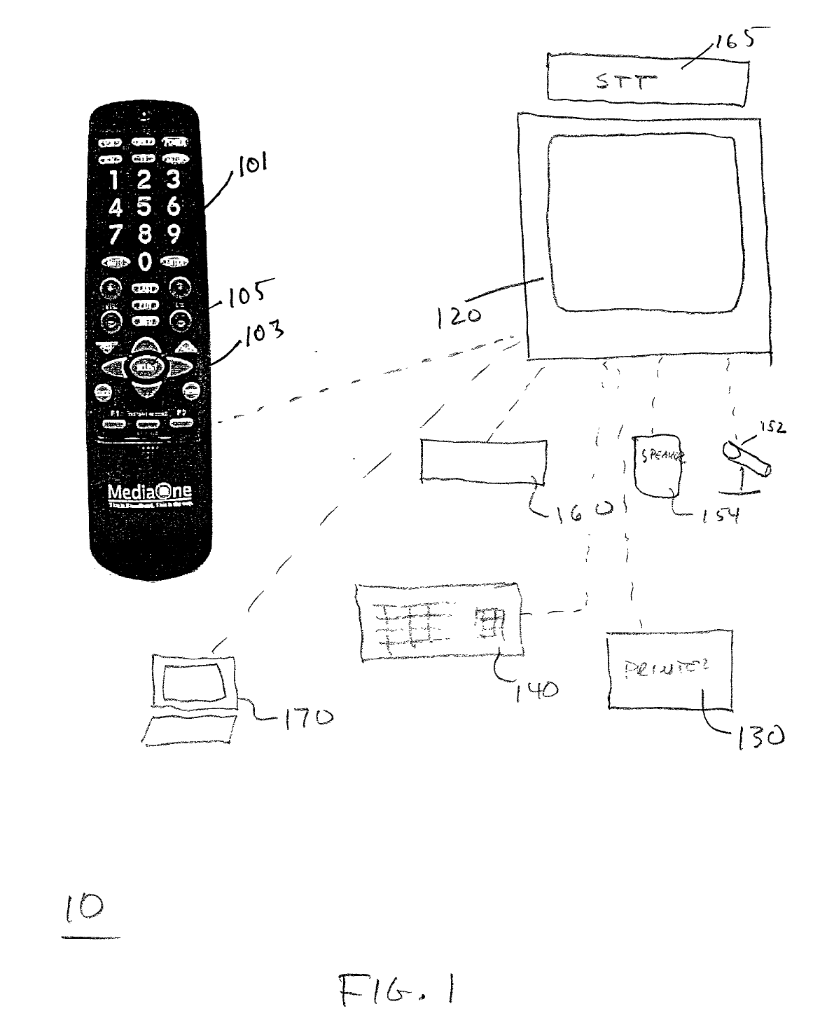

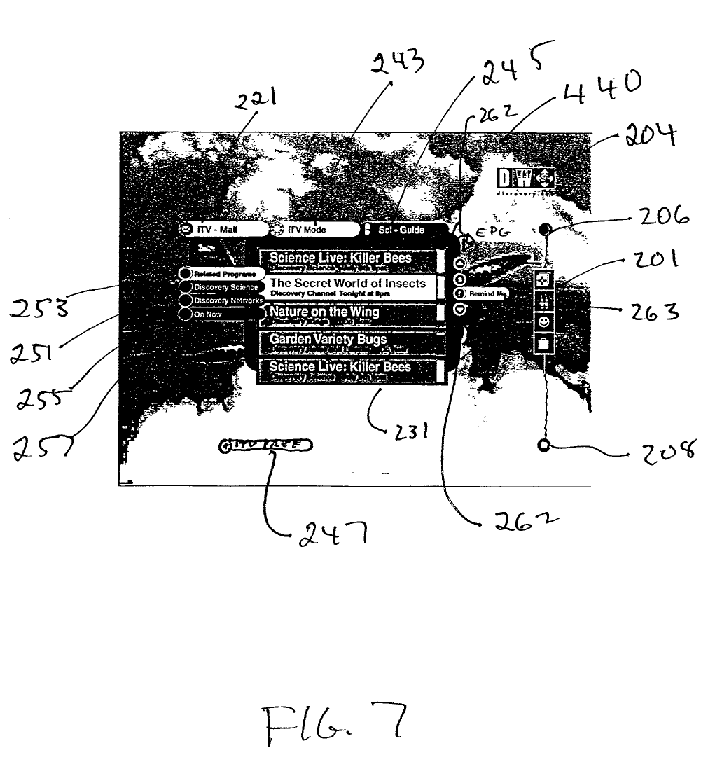

A novel user interface and electronic guide or navigator enhance the television viewing experience by providing an improved apparatus and method for navigating program choices, including navigating interactive program features. The apparatus includes a remote control device, processing hardware and memory, and an onscreen, or electronic navigator. FIG. 1 illustrates a system 10 that uses the electronic navigator. A remote control device 100 functions as part of a novel user interface. The remote control device 100 includes a numeric key pad 101, arrow keys 103, and a select button 105. The arrow keys 103 may move an onscreen cursor (not shown), or may simply be used to sequentially highlight programming choices, including interactive features, on the electronic navigator. The remote control device 100 may include other control buttons such as mute; previous channel or selection; power; and buttons to select between a television, a set top or satellite terminal, and a recording device, for example. The remote control device 100 may be used in conjunction with a viewer's terminal 120. The viewer's terminal 120 may be a television, a television set top terminal, a personal computer, a lap top computer, a dedicated electronic book reader, a personal data assistant (PDA), or any other wired or wireless device capable of displaying video. The viewer's terminal 120 may include a processor and memory necessary to form and display the navigator and other associated features. The viewer's terminal 120 will be described in more detail with reference to FIGS. 5 and 6. The viewer's terminal 120 also includes other components of the user interface, such as a visual display of the arrow keys, for example.

Also shown in FIG. 1 are peripheral devices that may enhance operation of the system 10. Such devices include a printer 130, a wireless keyboard 140, a video camera 150, a microphone 152 and speakers 154, a video recorder 160, and a set top terminal (STT) 165. The printer 130 may be used to print documents related to one or more of the interactive features launched using the electronic navigator. For example, the printer 130 may be used to print hard copy coupons from an interactive Web site. Alternatively, the printer 130 may print documents related to a displayed program. For example, a program dedicated to the life of Martin Luther King may include a time line of key events in the civil rights movement in the United States. The viewer may use the printer 130 to print a copy of this time line.

The wireless keyboard 140 may be used in lieu of, or as a supplement to the remote control device 100. The wireless keyboard 140 provides greater functionality and ease of use when, for example, the viewer is composing a long electronic mail message.

The video camera 150 may be used to facilitate video conferencing and transfer of images from one viewer to another viewer. Finally, the video recorder 160 may record programs or interactive events for later play back. The video recorder 160 may comprise a video cassette recorder or a hard drive or other magnetic, optical or mass storage device. The video recorder 160 may also be integrated into the viewer's terminal 120. Also shown in FIG. 1 is a personal computer 170 to which the viewer's terminal 120 may be coupled using wired or wireless means. The personal computer 170 may be used to display certain interactive features or events that are launched or activated using the user interface and navigator at the viewer's terminal 120.

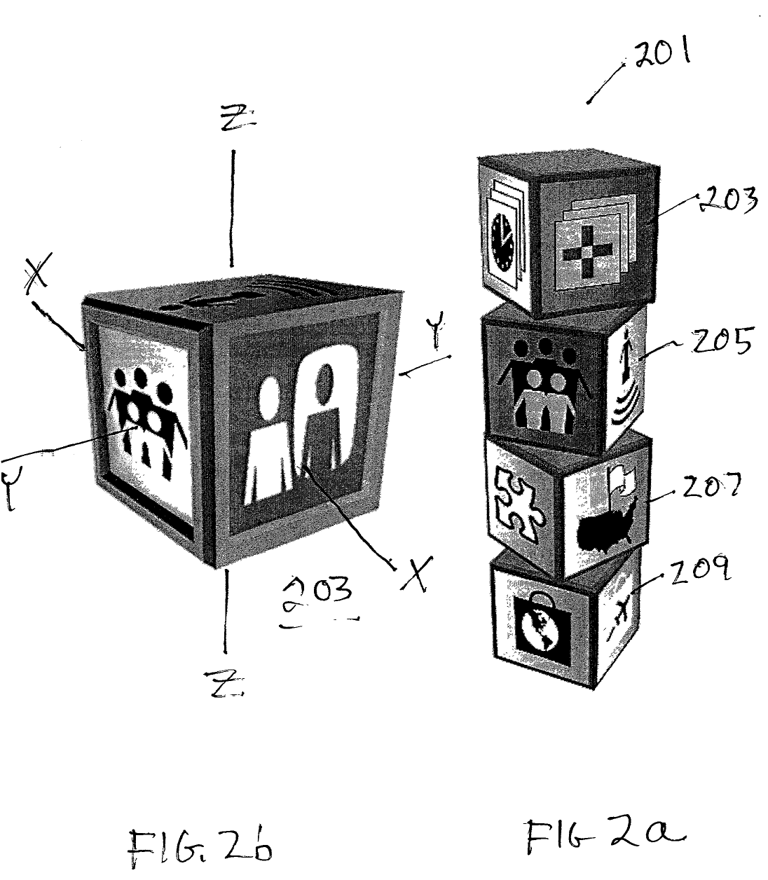

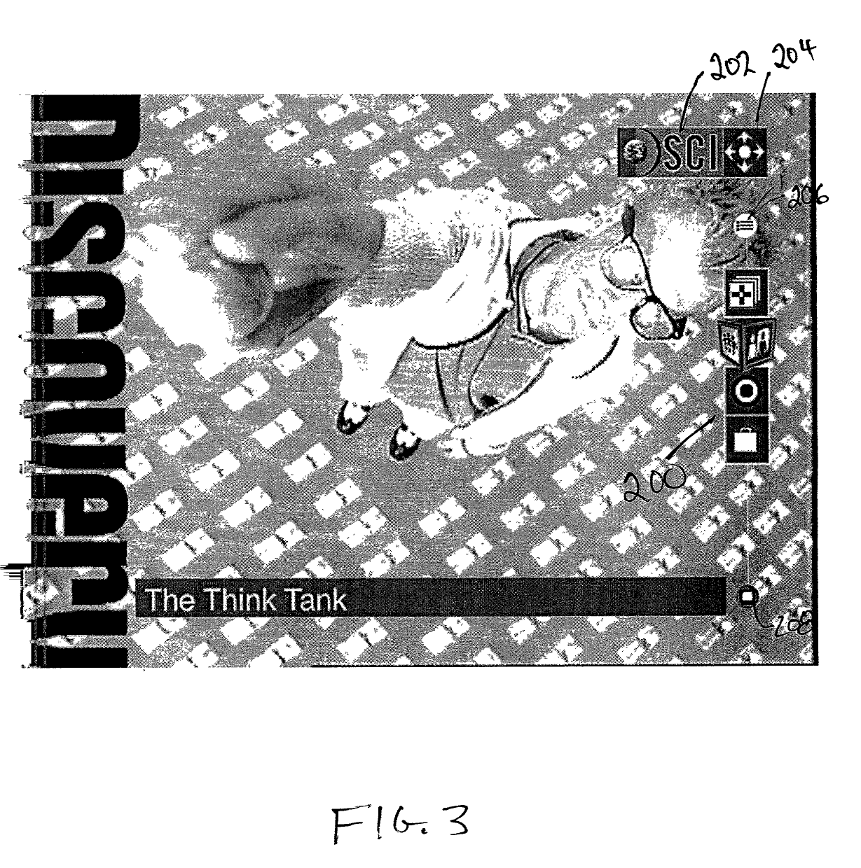

FIG. 2a illustrates an embodiment of a novel electronic navigator 200 that is displayed at the viewer's terminal 120. In the illustrated embodiment, the navigator 200 includes stacked, rotatable cubes 201, including a program enhancement cube 203, a community cube 205, a games cube 207 and an e-commerce cube 209. Although four cubes are shown, the navigator 200 is not limited to four cubes, and any number of cubes may be used with the navigator 200. Each of the cubes shown may include one or more choices displayed on a face of the cube. The choices may related to an interactive television feature or event, and selection of a specific choice may activate or launch the interactive feature or event.

The cubes may be made to rotate by operation of the arrow keys 103 on the remote control device 100 or similar keys on the wireless keyboard 140. For example, a down arrow of the arrow keys 103 may be used to scroll, or move down the stack of cubes (the navigator 200) to the cube 205. The select button 105 may then be operated to select the cube 205. Once selected, the cube 205 may be displayed in a “3-dimensional” format, while the remaining cubes 203, 207 and 209 are displayed in a flat, or “2-dimensional format.” Alternatively, the selected cube may be indicated by highlighting the selected cube, or by making the selected cube larger than non-selected cubes. Once the cube 205 is selected, further operation of the arrow keys 103 causes the cube 205 to rotate. The cube 205 may rotate such that any of its six faces is displayed and highlighted. For example, a counterclockwise (or left pointing) arrow key of the arrow keys 103 may be used to rotate the cube 205 counterclockwise. A single depression of the counterclockwise arrow key may cause the cube 205 to rotate one face. A continuous depression of the counterclockwise arrow key may cause the cube 205 to rotate continuously.

The remote control device 100 may transmit commands to the processor (see FIGS. 5 and 6) using infrared or radio frequency mechanisms. As an alternative, the processor may be configured to receive voice commands, or any other means for transmitting commands between the viewer and the processor.

FIG. 2b illustrates the community cube 205 showing its axes of rotation. As shown, the cube 205 may rotate around the X- and Y-axes. Such rotation exposes one of the six faces of the cube, and may cause the exposed face to be highlighted. The exposed face may then be selected by the viewer, thereby launching the associated interactive feature. In an alternative embodiment, the cube 205 may also rotate around the Z-axis.

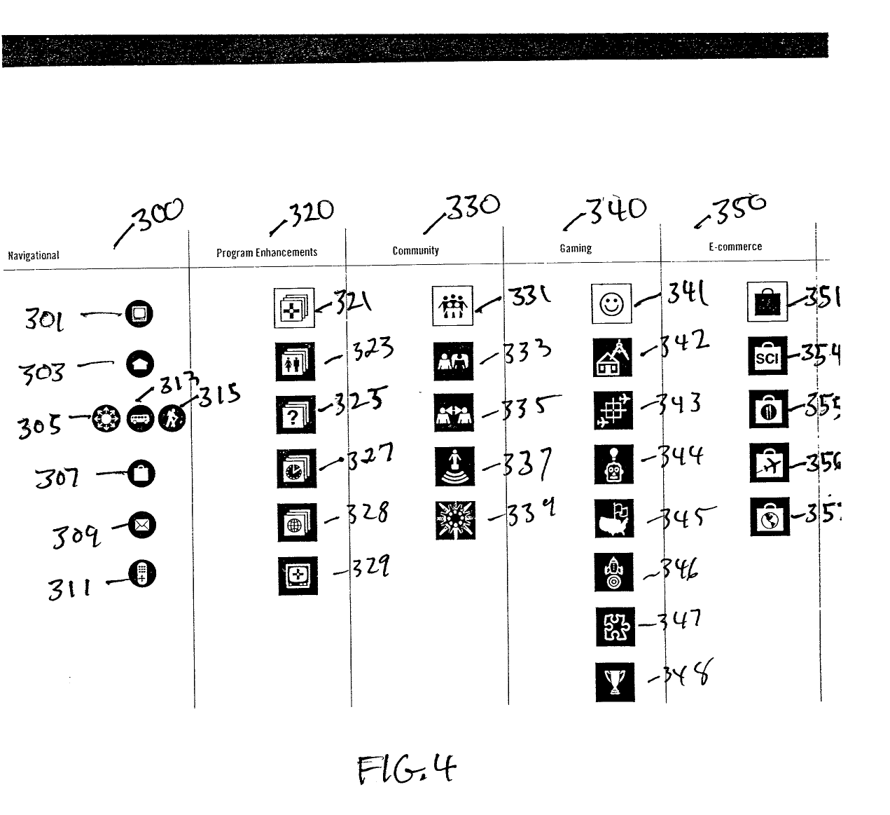

FIG. 3 illustrates the navigator 200 with the community cube 205 selected and displayed in 3-dimensional format and the cubes 203, 207 and 209 displayed in 2-dimensional format. The viewer's terminal 120 may always display a logo 202 and may display a navigator logo 204 whenever interactive features are available. The navigator 200 may be displayed when the viewer places a cursor on the navigator logo 204 and operates the select button 105 on the remote control device 100. Other features include an EPG button 206 ands a back to TV button 208.

In an alternative embodiment, the navigator 200 may be displayed automatically when interactive features are available.

In FIG. 3, the cube 205 shows faces 215 and 225, with the face 225 highlighted. To activate the interactive feature displayed on the face 225, the viewer may further operate the select button 105. Operation of the select button 105 then causes the processor (see FIGS. 5 and 6) to launch the interactive feature illustrated on the face 225.

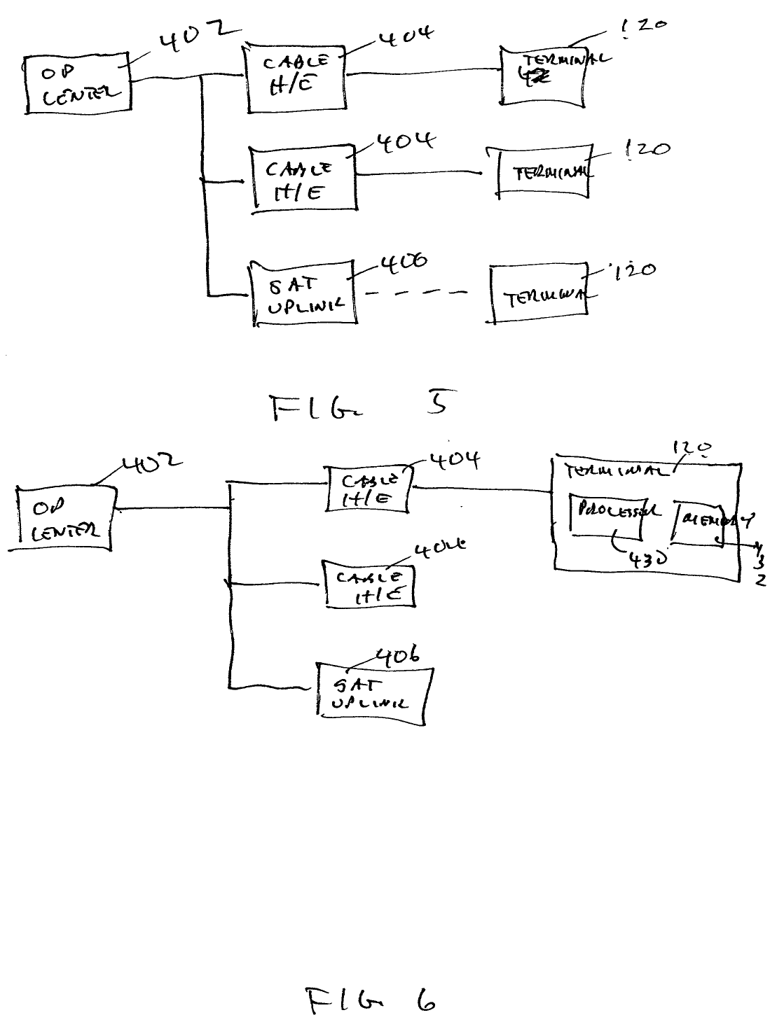

FIG. 4 illustrates various features and selections, including interactive features, that may be displayed in conjunction with the navigator 200. The features and selections are displayed in a tabular format to facilitate understanding of the navigator 200. However, the actual arrangement of the features and selections correspond to the structure of the navigator 200 of FIG. 2a.

A navigation section 300 includes one or more selections that may be used to navigate programming using the navigator 200. The selections are shown as icons. However, the selections may also be expressed in text, video, and numeric configurations. The selections include a back to television selection 301, a home selection 303, an iTV mode selection 305, an e-commerce selection 307, an e-mail selection 309, and an electronic program guide selection 311. The iTV selection 305 may also include a tour selection 313 and an explore selection 315, which will be described in detail later.

A program enhancements section 320 includes a set of feature that may be used to enhance a viewer's viewing experience. The program enhancement features are represented by an iconic images that may be displayed on the program enhancements cube 203 of the navigator 200. Program enhancements are indicated by a more feature 321 that indicates more information is available regarding a particular program or subject. The program enhancement features include a who feature 323 that may provide access to biographical information about one or more characters in a displayed program. A what feature 325 may provide access to descriptive or technical information about an event or object in the displayed program. A when feature 327 may provide historical information, including a time line, for example, related to an event, character, or object of a displayed program. A where feature 328 may provide geographical information, including a map, for example, related to a displayed program. Finally, a related programming feature 329 may provide a list of available programs that are related to a displayed program. Other program enhancement features may also be included in the program enhancements section 320. The program enhancement features listed above may be displayed during a display of the associated program, may be stored in a memory of the viewer's terminal 120 or in the video recorder 160, or may be printed using the printer 130.

A community section 330 includes features that provide communication services between the viewer and other individuals or between the viewer and characters in a displayed program. The community section 330 includes a community feature 331, which is displayed when the navigator 200 is first displayed on the viewer's terminal 120. By selecting the community feature 331, the community cube 205 is activated. Besides the community feature 331, the community section 330 includes an ask the expert feature 333, a buddy chat feature 335, a viewer forum feature 337 and a clubs feature 339. Other communication features may also be included in the community section 330.

The ask the expert feature 333 may allow the viewer to ask a question of a performer in a live television program, for example, and to receive a response during the display of the live television program, or at a later time. The question and the answer may be provided as text during display of the live program by use of a text window. Alternatively, the performer may provide the answer by way of a video and audio clip, which may then be provided in a picture-in-picture format or other video window format during the live program, or may be provided to the viewer at a later time, for example, by storing the video and audio clip at the viewer's terminal 120. Other mechanisms are also available to provide the questions and answers, including use of the Internet.

A buddy chat feature 335 allows two or more viewers to engage in a “conversation.” The conversation may include use of text messages that are displayed at the viewers' terminals 120, printed at the printer 130, or displayed on an attached personal computer, for example. The transmission of the text messages may be by way of the PSTN and the Internet, for example. In addition to text messages, the viewers may use the video cameras 150, the microphones 152, and the speakers 154 to provide video and audio communications.

The viewer forum feature 337 may allow viewer's to express opinions or post messages in a bulletin-board fashion, using the Internet, for example. The clubs feature 339 may allow viewers with common interests in a subject (such as a subject of a displayed program) to communicate regarding that subject. Such communication is advantageously conducted using the viewer's terminals 120 and the Internet.

A gaming section 340 is indicated by a play feature 341, and various games (represented by icons and/or text) that may be played on the viewer's terminal 120. The games may be played by one or more viewers at a single viewer's terminal 120, or by two or more viewers at more than one viewer's terminal 120. Examples of games include home designer 342, air traffic controller 343, brain bogglers 344, trivia 345, moon mission 346, puzzles 347 and contests 348. Games may be added to or deleted from the gaming section 340.

An e-commerce section 350 is indicated by a shop feature 351 and includes e-commerce features that may be activated from the viewer's terminal 120. Examples of such e-commerce features include a by network feature 353, a by genre feature 355, a travel feature 357 and a discovery feature 359. The e-commerce features allow the viewer to shop, make purchases, and arrange travel and vacations, for example.

The selection in the navigation section 300 may be made available to the viewer by means of selection buttons displayed as overlays on a program. When activated, the specific selections may generate the identified feature. For example, the electronic program guide selection 311 may be made available by an overlay EPG button (see FIG. 7, for example). When the EPG button is selected, an electronic program guide may be displayed. The electronic program guide may list available programs by date/time and channel number, and may be scrollable.

The iTV preferences selection may be available using an iTV button. Selecting the iTV button may make available a number of options that enhance the viewer's use of interactive television programming. For example, the iTV preferences may allow the viewer to enter a credit card number an expiration date that will subsequently be used for all online purchases executed using the e-commerce features. Other options include entry of the viewer's e-mail address that is automatically provided with other interactive features.

The iTV mode selection 305 and the tour selection 313 and explore selection 315 may be used to provide a guided tour of the interactive features, or to allow for a more advanced, free-form review of the interactive features.

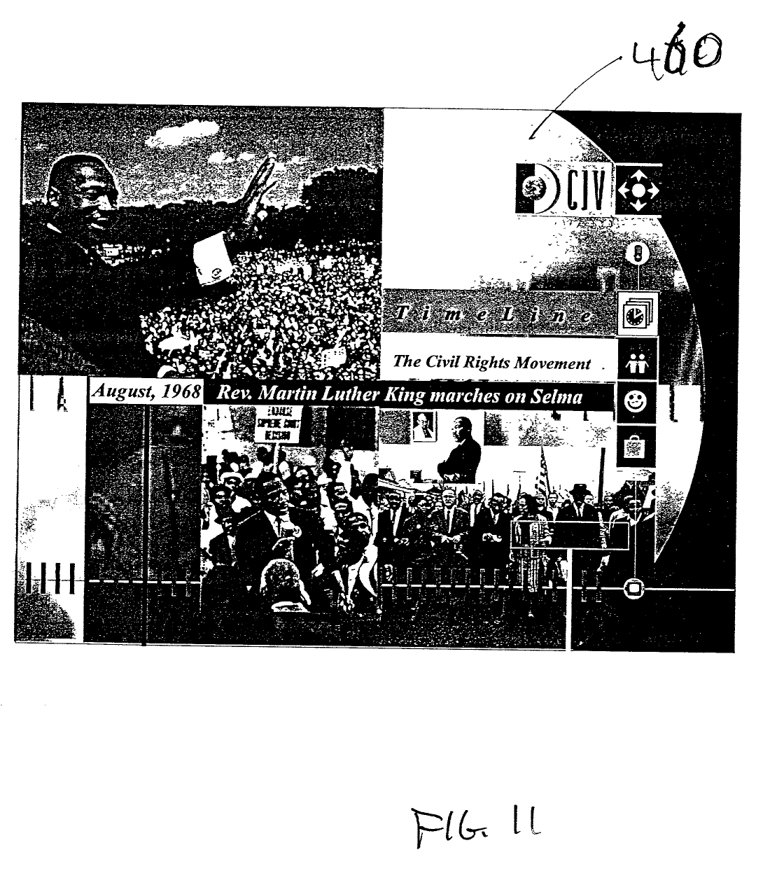

Each of the interactive features shown in FIG. 3 includes an icon that may be displayed on a face of a cube. However, the icons shown may be replaced by other icons, and/or the cube faces may also include text. In addition, or alternatively, each displayed cube face (with its icon) may be accompanied by a word cue that provides further information about the interactive feature (see, for example, FIG. 10).

The navigation selections shown in the navigation section 300 may be generally fixed. However such selections may be updated by reprogramming software that generates the navigation selections. The sets of features shown in the sections 320, 330, 340 and 350 may change based on a program being displayed at the viewer's terminal 120. For example, if a comedy program is displayed, the set of features may differ from those displayed when a sporting event is displayed. The sets of features may also be changed periodically by reprogramming the software that generates the feature sets. Reprogramming of the viewer's terminal 120 is described in detail in U.S. Pat. No. 5,798,785, entitled Reprogrammable Terminal For Suggesting Programs Offered on a Television Program Delivery System, the disclosure of which is hereby incorporated by reference.

FIG. 5 is a block diagram of a system 400 that uses the navigator 200 of FIG. 2a to provide interactive television programming at the viewers' terminal 120. The system 400 includes an operations center 402 that packages television programs and that may provide interactive features. Programs may be transmitted from the operations center 402 to one or more cable headends 404 for further delivery to the viewers' terminals 120. The programs may also be sent to a satellite uplink facility 406 for transmission directly to the viewers' terminals 120. The programs may be provided as part of a program feed that also includes the navigator 200. That is, the navigator 200 may be sent in the same manner as the television programs. The program feed may also include transmission of interactive features, such as video games.

FIG. 6 is a block diagram of an alternative system 500 that uses the navigator 200. The system 500 includes the operations center 402, the cable headends 404 and the satellite uplink facility 406 as before. The viewers' terminals 120 may include template data from which the navigator 200 is generated. Data necessary to generate, or populate, the navigator 200 may be stored in the viewers' terminals 120, or may be sent to the viewers' terminals 120 with the television program feed. Alternatively, the data necessary to generate the navigator 200 may be transmitted to the viewers' terminals 120 using alternative communications paths, such as the Internet, the public switched telephone network, or any other communications medium capable of transmitting digital data. The data necessary to generate the navigator 200, when received at the viewers' terminals 120, may be stored at the viewers' terminals 120 and may be combined with the template data to provide an onscreen display of the navigator 200.

In FIG. 6, the viewers' terminals 120 may include a processor 430 and a memory 432 that are used to generate the navigator 200. That is, the memory 432 may include the basic software and the template data necessary to create the rotating cube structure of the navigator 200, and the processor 430 may use the basic software and the template data, along with the data necessary to generate the navigator 200 to provide the onscreen display of the navigator 200.

To provide true interactivity for certain features, such as e-commerce features, the viewers' terminals 120 shown in FIGS. 5 and 6 may include the hardware and software necessary to transmit data upstream from the viewers' terminals 120 to a remote location, such as the cable headends 404 and the satellite uplink facility 406. The upstream data transmission may be by way of a cable modem and coaxial cable, a telephone modem and the PSTN or other telephone line, through the Internet, or by direct satellite uplink from the viewers' terminals 120. Other interactive features may be provided based on data and programming stored at the viewers' terminals 120. For example, the viewers' terminals 120 may store interactive video games that are accessed through the navigator 200.

In FIGS. 2-6, the navigator 200 was described as proving interactive features accessible through the viewer's terminal 120. In an embodiment, the navigator 200 may be configured to display other menu selections, and may, for example, be used to display an electronic program guide of available television programs. When used as an electronic program guide, the cubes in the navigator 200 may be structured in a hierarchical fashion. For example, one cube could represent available program channels (digital and analog) assigned to one broadcaster (e.g., NBC, ABC), and other cubes could represent available program channels for other broadcasters. In another embodiment, each cube may represent a specific genre of programs, such as comedies, first run movies, and dramas, for example. The faces of the cubes could then represent specific programs, or shows. The viewer may navigate the electronic program guide using the cursor arrows on the remote control device 100, and may select a specific program or channel for viewing by operating the select button 105. When used as an electronic program guide, the faces of the cubes in the navigator 200 may be supplemented with text information, such as the title of the program, its rating, start and end time, length, and similar data.

The navigator 200, the logo 202 and the navigator logo 204, may be displayed at the viewer's terminal 120 in an overlay fashion. Because of the compact size of the navigator 200, very little of the displayed program is obscured. Furthermore, the navigator 200 may only be displayed when the navigator logo 204 is selected.

The navigator 200 may include other overlay features and menus. FIGS. 7-13 illustrate some of these other features and menus. In FIG. 7, a program 440 is displayed on the viewer's terminal 120. The navigator logo 204 has been selected and the stacked, rotatable cubes 201 are displayed. Also displayed are an e-mail selection button 221, an iTV mode button 243, a science guide button 245, an iTV preferences button 247, the EPG button 206, and the return to TV button 208. As shown in FIG. 7, the viewer has selected the science guide button 245, and the processor has displayed a menu 231 of available programs. The menu 231 includes specific programs that the viewer can select for viewing. Each program listed in the menu 231 may include descriptive information about the program such as title, channel, start time, duration, rating, and other program-related data. The menu 231 is shown with five programs listed. However, the program 231 is not so limited, and any number of programs may be listed. The viewer may designate the number of programs to be listed (e.g., list five programs), or a default value may be used. Alternatively, the programs may be listed in a scrollable format such that the menu 231 displays a subset of the programs, with the displayed subset changing when the menu 231 is scrolled.

Associated with the menu 231 is a sub menu 251 of options that the viewer may select. The submenu 251 may include a listing 253 of programs related to a program highlighted in the menu 231. Other options may include a listing 255 of other science features and a list 257 of programs currently being broadcast, for example.

Also associated with the menu 231 is a sub menu 261 of available features including scrolling arrows 262 and a remind me button 263. The scrolling arrows 262 may be used for menu navigation. The remind me button 263 may be selected by the viewer to provide a reminder shortly before the scheduled display (broadcast) time of any selected program. The reminder may be provided by way of an overlay message, a synthesized voice message, or a message printed using the printer 130, for example.

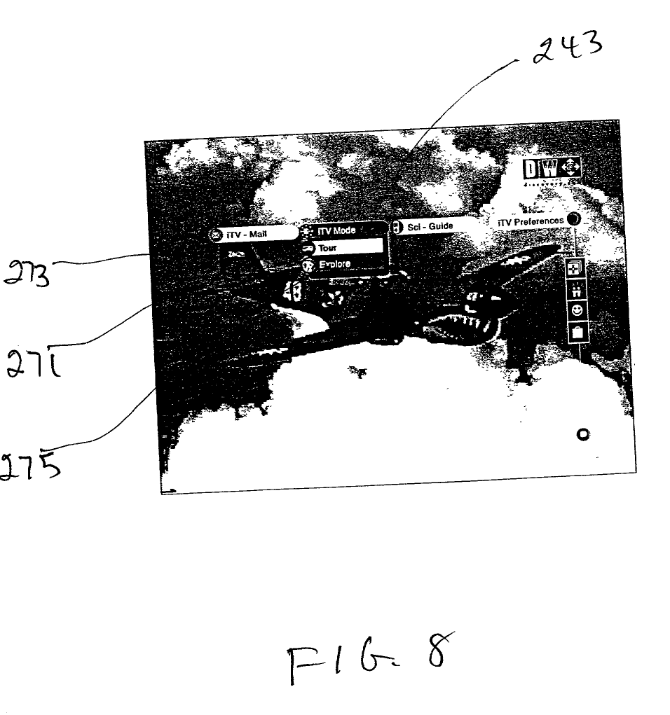

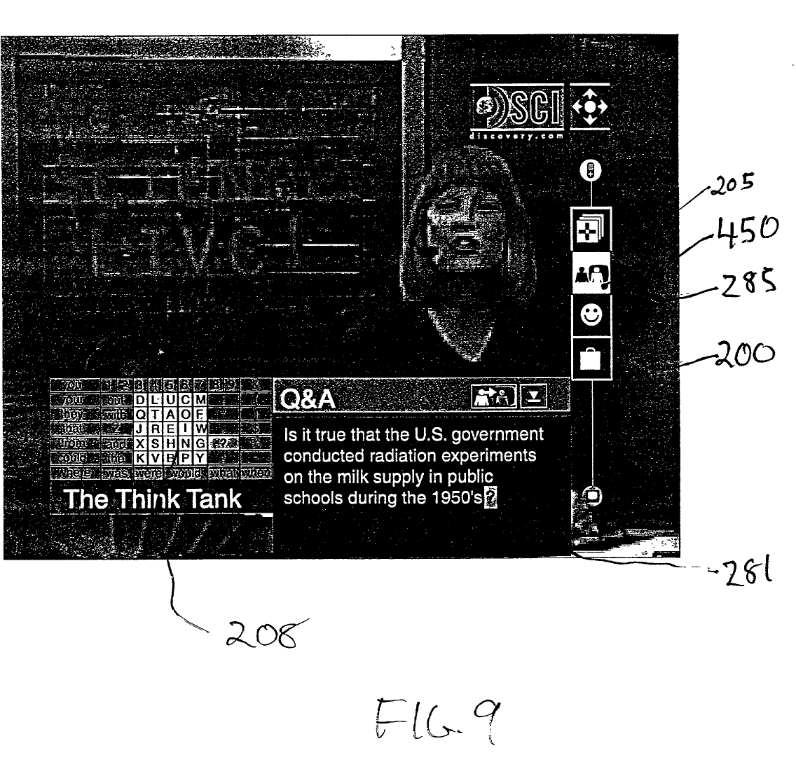

In FIG. 7, the various features and buttons, including, for example, the EPG button 248, are shown in a specific overlay location on the program 440. However, the features and buttons are not limited to these overlay locations, and other overlay locations may be used. FIG. 8 illustrates a pull-down menu 271 displayed when the iTV mode button 243 is selected. The menu 271 includes a selection 273 for an interactive television tour and a selection 275 for interactive explore. The menu 271 may represent the selections 271 and 273 as icons with or without associated text.

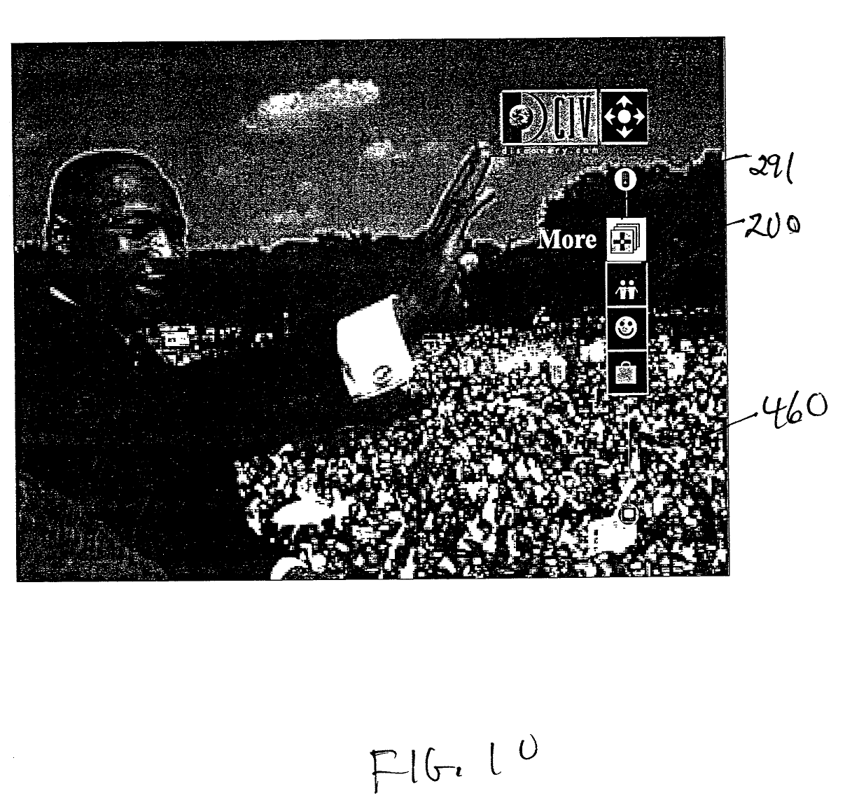

FIG. 9 illustrates a question and answer interactive feature that is accessible from the community cube 205. In FIG. 9, a live program 450 is shown with the navigator 200 displayed and the community cube 205 selected. An ask the expert feature 285 is specifically selected, causing a Q&A window 281 to be displayed in the lower third of the display. The Q&A window allows the viewer to send in a question to the live program 450 and to receive a reply (not shown). The reply, or answer, may be provided during the broadcast of the live program 450 or at a later time. When the reply is provided during the broadcast of the live program 450, the reply may be provided as a text message displayed in an overlay fashion or in a text box, as a picture-in-picture video and audio clip, or as a message printed using the printer 130. The lower third of the display also includes a soft keyboard 283, designed for use with the arrow keys 103 and select button 105 of the remote control device 100. The soft key board 283 is arranged with the most commonly used letters in the board's center. In addition, frequently used words are displayed to allow the viewer to select a shortcut alternative to typing.

FIG. 10 illustrates a program 460 about the life of Martin Luther King. The navigator 200 is shown overlaid on the program 460. The navigator 200 is shown with a word cue 291 (the word “MORE”). The word cue 291 may be used to help describe a feature icon displayed on a cube face of the navigator 200.

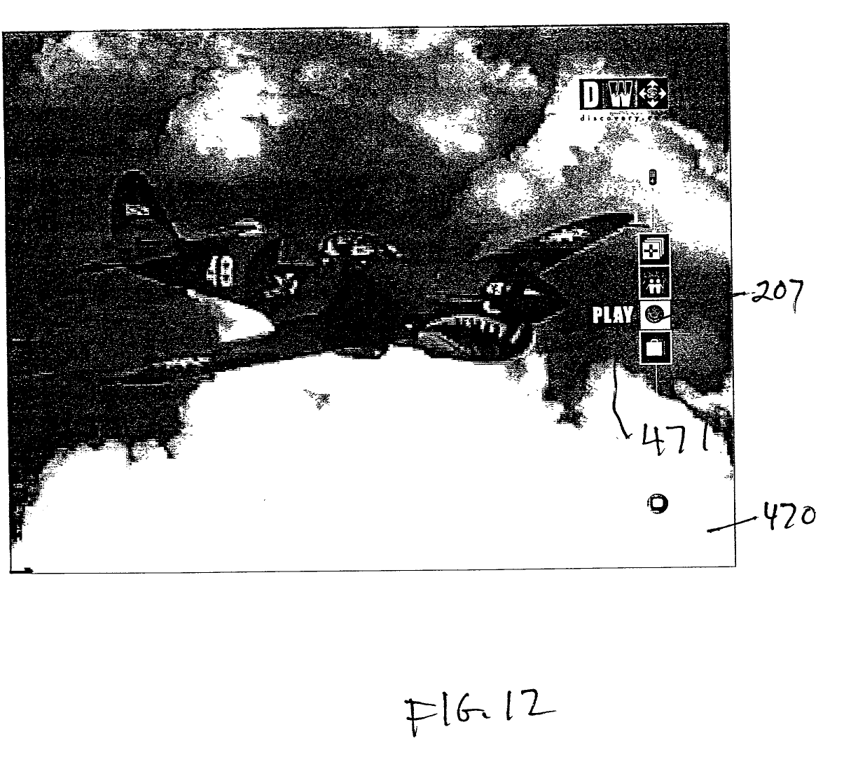

FIG. 11 illustrates the program 460 with a program enhancement feature selected from the navigator 200. In the illustrated example, the viewer has selected a time line program enhancement. When the program enhancement selected involves images as well as text, the linear program video (the program 460) may be squeezed back to ¼ frame size. The remainder of the display is used for other information such as an examination of the role Martin Luther King played in key event along a time line of the civil rights movement.

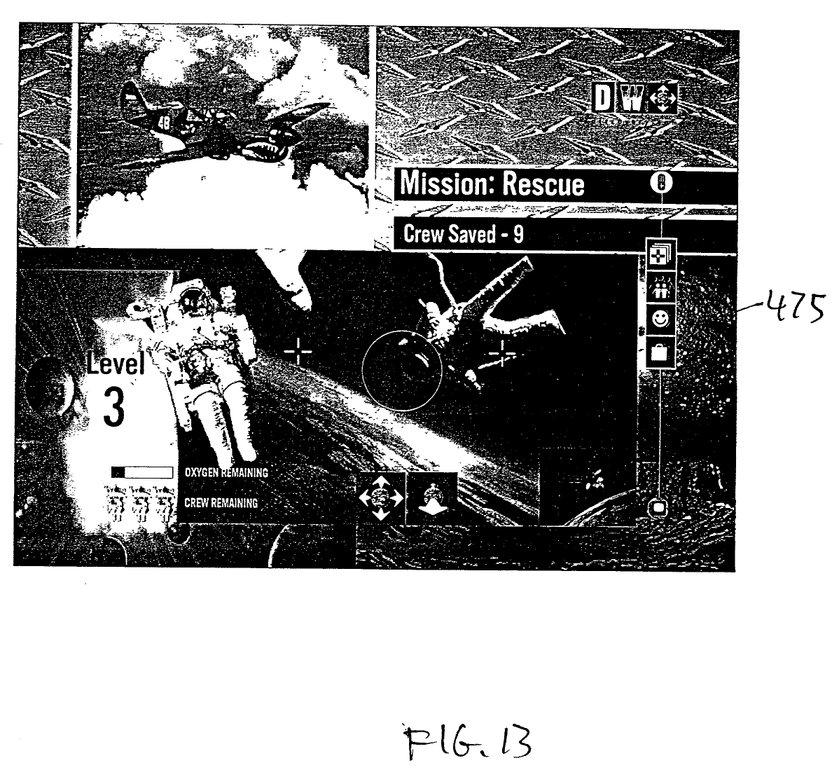

FIG. 12 illustrates a program 470 about World War II aircraft. The navigator 200 is displayed with the games cube 207 selected and a word cue 471 (the word “PLAY) inserted next to the games cube 207.

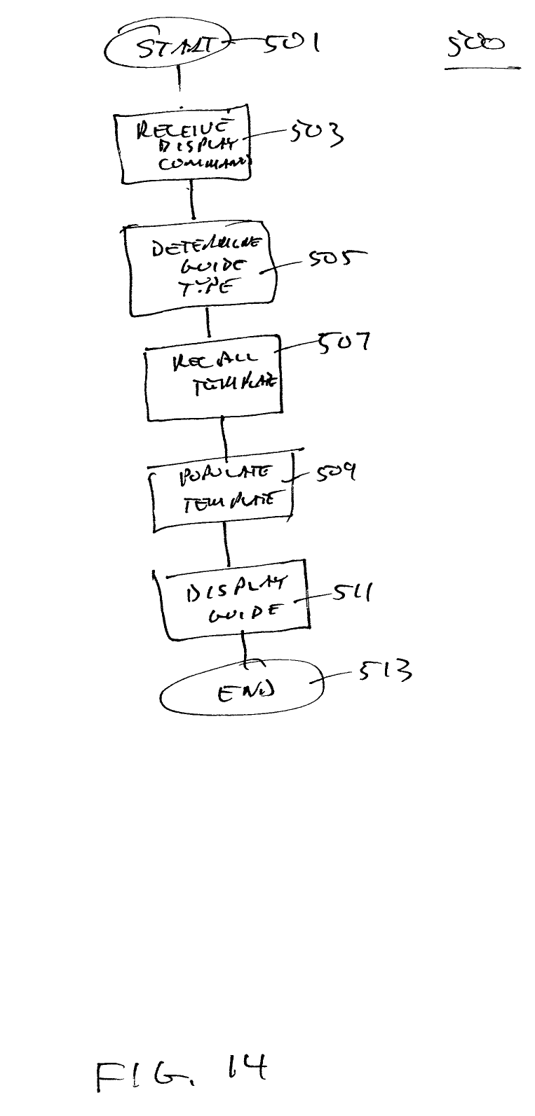

FIG. 13 illustrates a space rescue game 475 that the viewer has selected to play. As noted before, such games may be stored in the memory of the viewer's terminal, or may be provided as part of a program feed over a dedicated channel. Alternatively, the interactive features of the game may be such that two viewers may be linked to play a particular game. For example, two viewer's may be linked to play a video version of Battleship or chess. In the example illustrated in FIG. 13, the program 470 is squeezed back to the upper ¼ of the display, and the game is displayed on the remaining portion of the display. In the game 475, an aviation enthusiast viewer tests skill and nerve in a mission to rescue stranded crew members in outer space. The game 475 may include progressively more difficult levels. The astronauts and other figures and items in the game may be maneuvered using the arrow keys 103 of the remote control device 100.

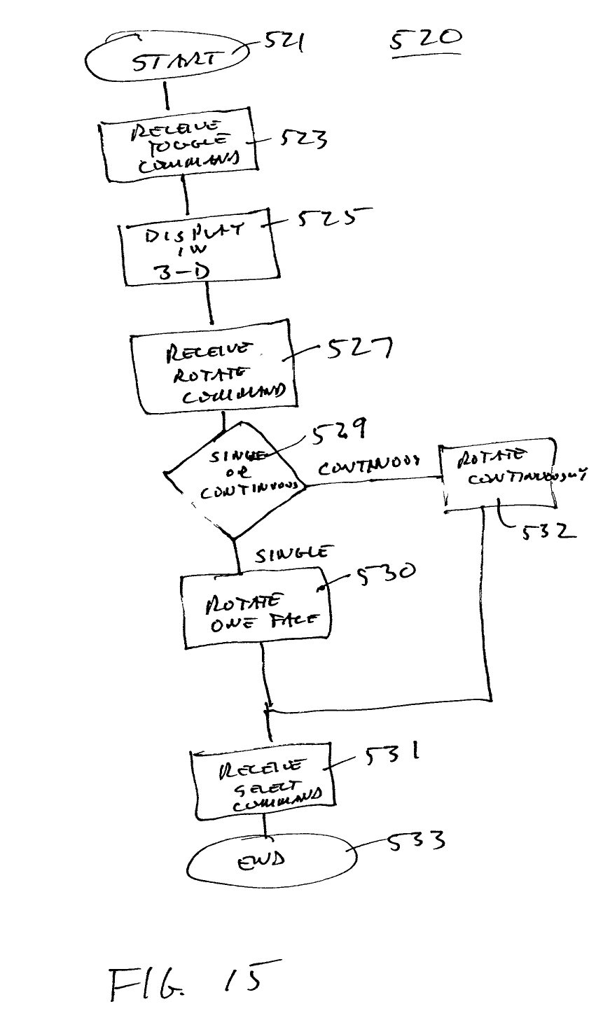

FIGS. 14 and 15 illustrate selected routines executed to provide the functions described above. In FIG. 14, a display navigator routine 500 is illustrated. The process begins in block 501. In block 503, the processor 430 receives a command to display the navigator 200. The processor 430 determines the type of navigator to be displayed (e.g., an interactive guide, and electronic program guide) based on the selection by the viewer, block 505. The processor then determines which program is currently displayed, and calls from memory an appropriate template for the selected navigator 200, block 507. In block 509, the processor populates the called template with program data to create the iconic representations of the navigator 200 features. Also called from memory may be any data addresses that are required to connect the viewer's terminal 120 to the selected interactive features. For example, an interactive feature that requires connection to an Internet Web site may cause the processor 430 to recall the Web site address such that when the feature is selected, the viewer's terminal is connected to the Web site. The program data may be called from the memory 432, and/or may be provided with the program feed. In block 511, the processor displays the navigator 200 as an overlay on the displayed program. The process then moves to block 513 and ends.

FIG. 15 illustrates a launch interactive feature routine 520. The process begins in block 521. In block 523, the processor 430 receives a command to toggle down to the program enhancements cube 203 and to select the program enhancements cube 203. In block 525, the processor 430 causes the program enhancements cube 203 to be displayed in a 3-dimensional format. In block 527, the processor 420 receives a command (consisting of a single depression of the counter clockwise arrow key) to rotate the program enhancements cube 203 counter clockwise (i.e., around the Y-axis). In block 529, the processor 430 determines that the rotate command is a single face rotation, and causes the program enhancements cube 203 to rotate counterclockwise one face, block 530. If, in block 529, the processor 430 determines that rotation is to be continuous, the processor executes block 532. In block 531, the processor 430 receives a command to launch a selected interactive feature. Using the example illustrated in FIGS. 10 and 11, the processor 430 causes the displayed program to be squeezed back to the upper left ¼ of the display, and inserts a time line feature showing Martin Luther King's involvement in the civil rights movement in text and video. The text and video may be received at the viewer's terminal 120 as part of the program feed, or may be stored in the memory 432. In block 533, the process ends.

The navigator 200 described above includes a stack of cubes 201 that contains selectable features. However, the navigator 200 is not limited to a stack of cubes. Other 2- or 3-dimensional objects may also be used with the navigator 200. For example, the stack of cubes 201 may be replaced with a rotatable sphere. When the navigator 200 is in the shape of a sphere, each “face” (the interactive selections) may be delineated by latitude and longitude. The stack of cubes may also be replaced by a rotatable cylinder, a pyramid, and a two-sided, rotatable plane. Other shapes may also be used with the navigator 200.

In the claims:

1. A interactive television navigator, comprising:
one or more solid, rotatable objects, each of the one or more rotatable solid objects including at least one face, the at least one face displaying an interactive program selection; and
a viewer interface, comprising:
one or more arrow keys operable to cause rotation of the one or more solid, rotatable objects, and
a select key operable to select the interactive program selection.

2. The interactive television navigator of claim 1, wherein each of the one or more solid, rotatable objects is configured to rotate around an X-axis and a Y-axis.

3. The interactive television navigator of claim 1, wherein the arrow keys comprise:
a single face rotation function, whereby the one or more solid, rotatable objects rotate one face; and
a continuous face rotation function, whereby the one or more solid, rotatable objects rotate continuously.

4. The interactive television navigator of claim 1, wherein the one or more rotatable, solid objects comprise a cube.

5. The interactive navigator of claim 1, wherein the one or more rotatable, solid objects comprise a sphere.

6. The interactive television navigator of claim 1, wherein the one or more solid objects are displayed in an overlay fashion on a program.
